(19) United States
(12) Patent Application Publication
(10) Pub. No.: US 2014/0085233 A1
(43) Pub. Date: Mar. 27, 2014

(54) ELECTRONIC APPARATUS AND METHOD FOR CONTROLLING SAME

(71) Applicant: CANON KABUSHIKI KAISHA, Tokyo (JP)

(72) Inventor: Koji Sudo, Machida-shi (JP)

(73) Assignee: CANON KABUSHIKI KAISHA, Tokyo (JP)

(21) Appl. No.: 13/970,415

(22) Filed: Aug. 19, 2013

(30) Foreign Application Priority Data
Aug. 22, 2012 (JP) 2012-183526

(51) Int. Cl. G06F 3/041

(52) U.S. Cl. CPC G06F 3/041
USPC 345/173

(57) ABSTRACT

An electronic apparatus includes a first operation unit, a second operation unit capable of accepting a touch operation, and a control unit configured to perform control to change a parameter of a first type if the first operation unit is operated without a touch operation performed on the second operation unit and change a parameter of one of a plurality of types if the first operation unit is operated with a touch operation performed on the second operation unit, the plurality of types including at least a second type and a third type.

### BACKGROUND OF THE INVENTION

1. Field of the Invention

The present invention relates to an electronic apparatus and a method for controlling the same.

2. Description of the Related Art

Electronic apparatuses equipped with a rotatable operation member such as an electronic dial have recently been in the market. The rotatable operation member may be used in combination with other members to set a plurality of parameters so that many parameters can be controlled by fewer operation members. Japanese Patent Application Laid-Open No. 2003-134462 discusses an image capturing apparatus in which a lens position control signal is supplied to an imaging unit when a dial is rotated to either side while pressing a button, and a compression rate control signal is supplied to a compression coding unit when the dial is rotated without pressing the button.

Electronic apparatuses equipped with a touch panel have also become widespread. Japanese Patent Application Laid-Open No. 3-77119 discuses that a shift key and a character key A of a keyboard displayed on a touch panel can be simultaneously touched to allow the detection of a shift operation (multiple input detection) similar to that of a keyboard.

However, according to Japanese Patent Application Laid-Open No. 2003-134462 and Japanese Patent Application Laid-Open No. 3-77119, it is only possible to switch two types of operations. It is not possible to quickly switch and change many types of parameters by using an operation member for setting a parameter like a rotatable operation member.

### SUMMARY OF THE INVENTION

The present invention is directed to an electronic apparatus in which a plurality of types of parameters can be quickly switched and changed by using an operation unit for setting a parameter.

According to an aspect of the present invention, an electronic apparatus includes a first operation unit, a second operation unit capable of accepting a touch operation, and a control unit configured to perform control to, if the first operation unit is operated without a touch operation performed on the second operation unit, change a parameter of a first type, and if the first operation unit is operated with a touch operation performed on the second operation unit, change a parameter of a type according to the touch operation, among a plurality of types including at least a second type and a third type.

According to the present invention, a plurality of types of parameters can be quickly switched and changed by using an operation unit for setting a parameter.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are outer appearance views of a digital camera according to an exemplary embodiment.

FIG. 2 is a block diagram illustrating a configuration of the digital camera according to the present exemplary embodiment.

FIGS. 3A to 3F are diagrams illustrating a setting screen that transitions according to an operation of the present exemplary embodiment.

FIG. 4 is a flowchart illustrating processing of the digital camera according to the present exemplary embodiment in a photographing mode.

FIG. 5 is a flowchart divided into a first part as shown in FIG. 5A and a second part as shown in FIG. 5B, illustrating processing for touch ring setting of the digital camera according to the present exemplary embodiment.

FIG. 6 is a diagram illustrating a position where a pullout area is displayed according to the present exemplary embodiment is arranged.

### DESCRIPTION OF THE EMBODIMENTS

Various exemplary embodiments, features, and aspects of the invention will be described in detail below with reference to the drawings.

It is to be noted that the following exemplary embodiment is merely one example for implementing the present invention and can be appropriately modified or changed depending on individual constructions and various conditions of apparatuses to which the present invention is applied. Thus, the present invention is in no way limited to the following exemplary embodiment.

The following exemplary embodiment is a case where the electronic apparatus according to the present invention is applied to an image capturing apparatus, or digital camera, capable of capturing still images and moving images as an example.

### (Configuration of Digital Camera)

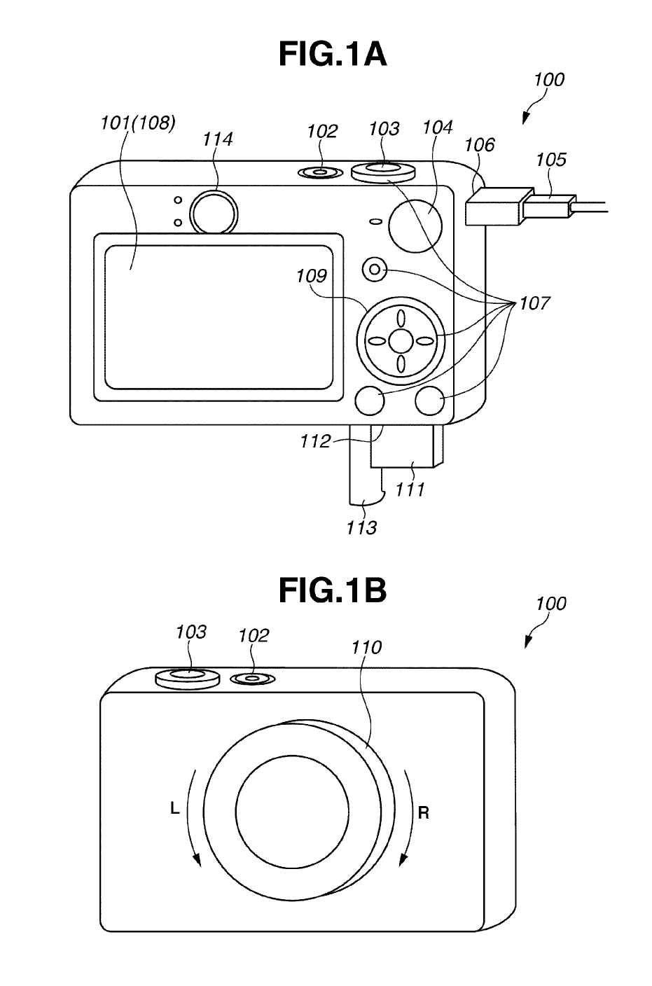

FIGS. 1A and 1B are outer appearance views of a digital camera 100 according to the exemplary embodiment. FIG. 1A is an outer perspective view of a rear side of the digital camera 100. FIG. 1B is an outer perspective view of a lens side of the digital camera 100.

A display unit 101 displays images and various types of information. A power switch 102 is a switch for switching between power-on and power-off. A shutter button 103 is a button for a user to issue a shooting instruction. A mode changing switch 104 is a switch for the user to switch various modes of the digital camera 100. Specifically, the user can switch the digital camera 100 to a still image recording mode, a moving image recording mode, and a playback mode. The digital camera 100 can be connected to an external apparatus via a connection cable 105. The connection cable 105 can connect to the digital camera 100 when inserted into a connector 106 of the digital camera 100.

Operation units 107 accept various operations from the user. The operation units 107 include various buttons illustrated in the diagrams and operation members such as a touch panel 108 arranged on a screen of the display unit 101. Specific examples of the buttons of the operation units 107 include a delete button, a menu button, a set button, a display button, a zoom operation unit, a four-way button (arrow buttons) arranged in a cross shape, a wheel 109, and a controller ring 110 (see FIG. 1B). The controller ring 110 is a rotatable operation member arranged around a lens barrel. The controller ring 110 can set a shutter speed, aperture, zoom, and focus. The controller ring 110 can be rotated in a first direction R and a second direction L different from the first direction R, which are illustrated in FIG. 1B. The controller ring 110 is an example of a first operation unit.

A recording medium 111 such as a memory card and a hard disk can be attached to the digital camera 100. A recording medium slot 112 accommodates the recording medium 111. The recording medium 111 accommodated in the recording medium slot 112 can communicate with the digital camera 100. A lid 113 can close the recording medium slot 112.

An optical finder 114 is intended for the user to check an object and an angle of view. The angle of view of the optical finder 114 is changed according to a zoom position of a shooting lens.

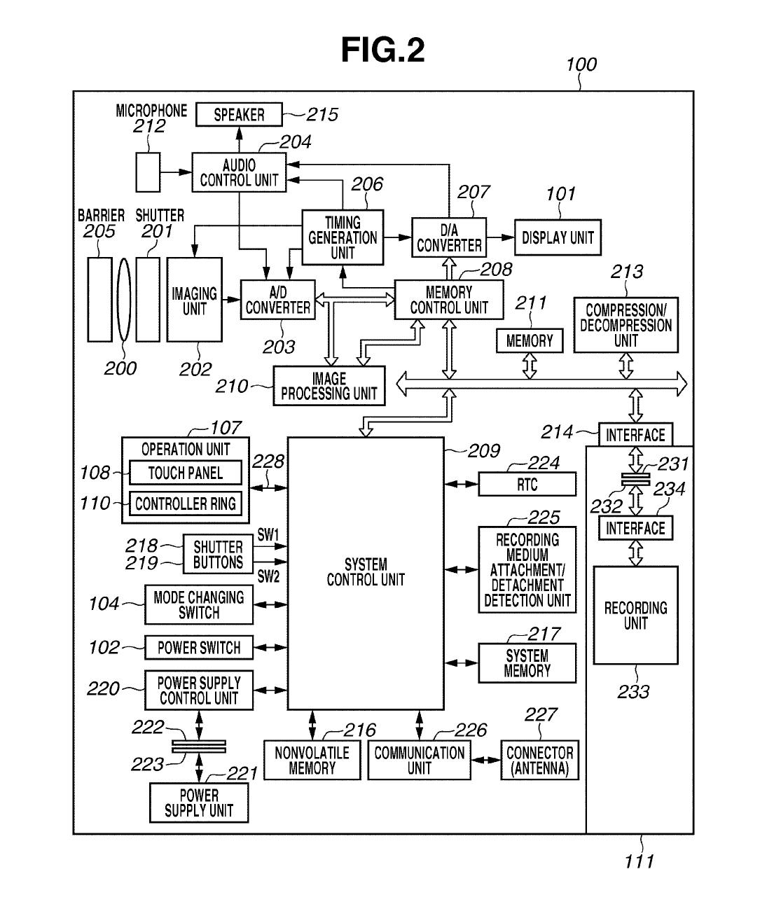

FIG. 2 is a block diagram illustrating a configuration of the digital camera 100. Similar components to those of FIGS. 1A and 1B are designated by the same reference numerals. A description thereof will be omitted.

A shooting lens 200 is a lens group including a zoom lens and a focus lens. A shutter 201 has a diaphragm function. An imaging unit 202 is an image sensor including a charge-coupled device (CCD) or complementary metal oxide silicon (CMOS) element for converting an optical image into an electrical signal. An analog-to-digital (A/D) converter 203 converts an analog signal output from the imaging unit 202 into a digital signal. The A/D converter 203 also converts an analog signal output from an audio control unit 204 into a digital signal. A barrier 205 covers the shooting lens 200 of the digital camera 100, thereby preventing contamination and breakage of an imaging optical system including the shooting lens 200, the shutter 201, and the imaging unit 202.

A timing generation unit 206 supplies a clock signal and/or a control signal to the imaging unit 202, the A/D converter 203, the audio control unit 204, and a digital-to-analog (D/A) converter 207. The timing generation unit 206 is controlled by a memory control unit 208 and a system control unit 209. An image processing unit 210 performs predetermined resize processing, such as pixel interpolation and reduction, and color conversion processing on image data from the A/D converter 203 or image data from the memory control unit 208. The image processing unit 210 performs predetermined calculation processing by using captured image data. Based on the obtained calculation result, the system control unit 209 performs an exposure control and a focusing control. By such processing, the system control unit 209 performs through-the-lens (TTL) automatic focus (AF) processing, automatic exposure (AE) processing, and electronic flash preliminary emission (EF) processing. The image processing unit 210 also performs predetermined calculation processing by using the captured image data, and performs TTL automatic white balance (AWB) processing based on the obtained calculation result.

The image data from the A/D converter 203 is written into a memory 211 via the image processing unit 210 and the memory control unit 208, or directly through the memory control unit 208. The memory 211 stores image data captured by the imaging unit 202 and converted into digital data by the A/D converter 203, and image data to be displayed on the display unit 101. The memory 211 is also used to store audio data recorded by a microphone 212, still images, moving images, and file headers for creating image files. The memory 211 thus has a storage capacity sufficient to store a predetermined number of still images and a predetermined duration of moving images and sound. The memory 211 also serves as a memory intended for image display (video memory).

A compression/decompression unit 213 compresses and decompresses image data by using an adaptive discrete cosine transform (ADCT). The shutter 201 serves as a trigger to store the image data in the memory 221. The compression/decompression unit 213 reads image data stored in the memory 221, performs compression processing, and writes the processed image data into the memory 211. The compression/decompression unit 213 performs decompression processing on a compressed image read from a recording unit 233 of the recording medium 111 into the memory 211, and writes the processed image data into the memory 211. The system control unit 209 includes a file unit, which makes the image data written in the memory 211 into a file, and records the file on the recording medium 111 via an interface 214.

The D/A converter 207 converts image data stored for display in the memory 211, into an analog signal and supplies the analog signal to the display unit 101. The image data for display written into the memory 211 is thus displayed on the display unit 101 via the D/A converter 207.

An audio signal output from the microphone 212 is supplied to the A/D converter 203 via the audio control unit 204 which includes an amplifier. The A/D converter 203 converts the audio signal into a digital signal. The memory control unit 208 stores the converted digital signal into the memory 211. On the other hand, audio data recorded on the recording medium 111 is read into the memory 211 and the D/A converter 207 converts the audio data into an analog signal. Using the analog signal, the audio control unit 204 drives a speaker 215 to output sound.

The display unit 101 performs display according to the analog signal from the A/D converter 207 on a monitor such as a liquid crystal display (LCD).

A nonvolatile memory 216 is an electrically erasable and recordable memory. Examples of the nonvolatile memory 216 include an electrically erasable programmable read-only memory (EEPROM). Operation constants of the system control unit 209 and a program are recorded in the nonvolatile memory 216. The program is intended to execute various flowcharts of the present exemplary embodiment to be described below.

The system control unit 209 controls the entire digital camera 100. The system control unit 209 is an example of a control unit and a display control unit. The system control unit 209 executes the program recorded in the nonvolatile memory 216 to implement the processing of the present exemplary embodiment as described below. A system memory 217 may be a random access memory (RAM), for example. The operation constants of the system control unit 209, variables, and the program read from the nonvolatile memory 216 are loaded into the system memory 217.

The operation units 107, the mode changing switch 104, a first shutter switch 218, a second shutter switch 219, and the power switch 102 are an operation means for inputting various operation instructions to the system control unit 209.

The mode changing switch 104 can change an operation mode of the system control unit 209 to any one of the still image recording mode, the moving image recording mode, and the playback mode.

The first shutter switch 218 is turned on to generate a first shutter switch signal SW1 in the middle of an operation of the shutter button 103 of the digital camera 100, i.e., when the shutter switch is half-pressed (shooting preparation instruction). Based on the first shutter switch signal SW1, the system control unit 209 starts operations of the AF processing, the AE processing, the AW processing, and/or the EF processing.

The second shutter switch 219 is turned on to generate a second shutter switch signal SW2 when an operation of the shutter button 103 of the digital camera 100 is completed, i.e., full-pressed (shooting instruction). Based on the second shutter switch signal SW2, the system control unit 209 starts a series of operations for shooting processing, from reading a signal from the imaging unit 202 to writing image data into the recording medium 111.

The user may select and operate various function icons displayed on the display unit 101 to assign appropriate functions to the operation members of the operation units 107 in each scene. The operation members thus function as various function buttons. Examples of the function buttons include an end button, a back button, an image advancing button, a jump button, a search button, and an attribute change button. For example, if the user presses a menu button, a menu screen capable of making various settings is displayed on the display unit 101. The user can intuitively make various settings by using the menu screen displayed on the display unit 101, the four-way button, and the set button.

A power supply control unit 220 includes a battery detection circuit, a direct-current-to-direct-current (DC-DC) converter, and a switch circuit for switching over blocks which are to be energized. The power supply control unit 220 detects the presence or absence of a battery, the type of the battery, and the remaining battery level. Based on the detection results and an instruction from the system control unit 209, the power supply control unit 220 controls the DC-DC converter to supply necessary voltages to various parts including the recording medium 111 for necessary periods. A power supply unit 221 includes a primary battery such as an alkali battery and a lithium battery, a secondary battery such as a nickel-cadmium (NiCd) battery, a nickel metal hydrate (NiMH) battery, and a lithium (Li) ion battery, and/or an alternating-current (AC) adapter. Connectors 222 and 223 connect the power supply control unit 220 and the power supply unit 221.

A real time clock (RTC) 224 clocks a date and time. The RTC 224 includes a power supply unit separate from the power supply control unit 220, and continues clocking even if the power supply unit 221 is turned off. The system control unit 209 sets a system timer by using the date and time acquired from the RTC 224 upon start-up, and performs a timer control.

An interface 214 is an interface with the recording medium 111. Connectors 231 and 232 connect the recording medium 111 and the interface 214. A recording medium attachment/detachment detection unit 225 detects whether the recording medium 111 is attached to the connector 231.

The recording medium 111 includes the recording unit 233, an interface 234 with the digital camera 100, and the connector 232 for connecting to the digital camera 100. The recording unit 233 includes a semiconductor memory and/or a magnetic disk.

A communication unit 226 performs various types of communication processing using Recommended Standard 232 version C (RS-232C), a universal serial bus (USB), IEEE 1394, P1284, Small Computer System Interface (SCSI), a modem, a local area network (LAN), and/or wireless communication. A connector (in the case of wireless communication, an antenna) 227 connects the digital camera 100 with another apparatus via the communication unit 226.

As described above, the digital camera 100 includes the touch panel 108 as one of the operation units 107. The touch panel 108 can detect a touch operation on the display unit 101. The touch panel 108 is an example of a second operation unit.

The touch panel 108 and the display unit 101 may be integrally formed. For example, the touch panel 108 is attached onto a display surface of the display unit 101 so that the light transmittance of the touch panel 108 will not interfere with a display of the display unit 101. Input coordinates on the touch panel 108 and display coordinates on the display unit 101 can be associated with each other to construct a graphical user interface (GUI) as if the user can directly operate the screen displayed on the display unit 101.

The touch panel 108 may use any one of various methods including a resistive film method, a surface capacitance method, a surface acoustic wave method, an infrared method, an electromagnetic induction method, an image recognition method, and an optical sensor method.

The system control unit 209 can detect the following operations on the touch panel 108 by the user. When the user uses a finger, a pen, or other object to touch the touch panel 108, the start of touching the touch panel 108 is referred to as a “touch-down” state. Once the user touches down the touch panel 108, the user may continuously touching the touch panel 108 or move the touch position on the touch panel 108 by dragging, rotating, or directing the touch point towards other position or direction of the touch panel 108. The continuous touch and the movement without releasing the finger, pen, or object from the touch panel 108 are referred to as touch-on. When the user releases the finger or pen from the touch panel 108, the user “touches up” the touch panel 108. The termination of the touch-down or touch-on state is referred to as a touch-up state. When all of the fingers, pens, and/or objects are released from the touch panel 108, that is, when all touch-down and touch-on states are terminated, a state of “touch-off” is entered into.

The foregoing operations and position coordinates of the finger or pen touching the touch panel 108 are notified to the system control unit 209 through an internal bus 228. Based on the notified information, the system control unit 209 determines what operation has been made on the touch panel 108. As for a move, the system control unit 209 can determine both vertical and horizontal components of a moving direction of the finger or pen moving on the touch panel 108 based on a change in the position coordinates. An operation of making a touch-down on the touch panel 108, followed by a certain move and a touch-up, draws a stroke. An operation of quickly drawing a stroke is called a flick. A flick is an operation to quickly move a finger touching the touch panel 108 over a certain distance and then release the finger. In other words, a flick is an operation to quickly sweep the touch panel 108 with a finger. If the system control unit 209 detects a move over a predetermined distance or more at a predetermined speed or higher and then detects a touch-up, the system control unit 209 determines that the flick has been made. If the system control unit 209 detects a move over a predetermined distance or more below a predetermine speed, the system control unit 209 determines that a drag has been made.

### (Screen Transitions in Touch & Ring Operation (Touch Panel & Controller Ring Operation))

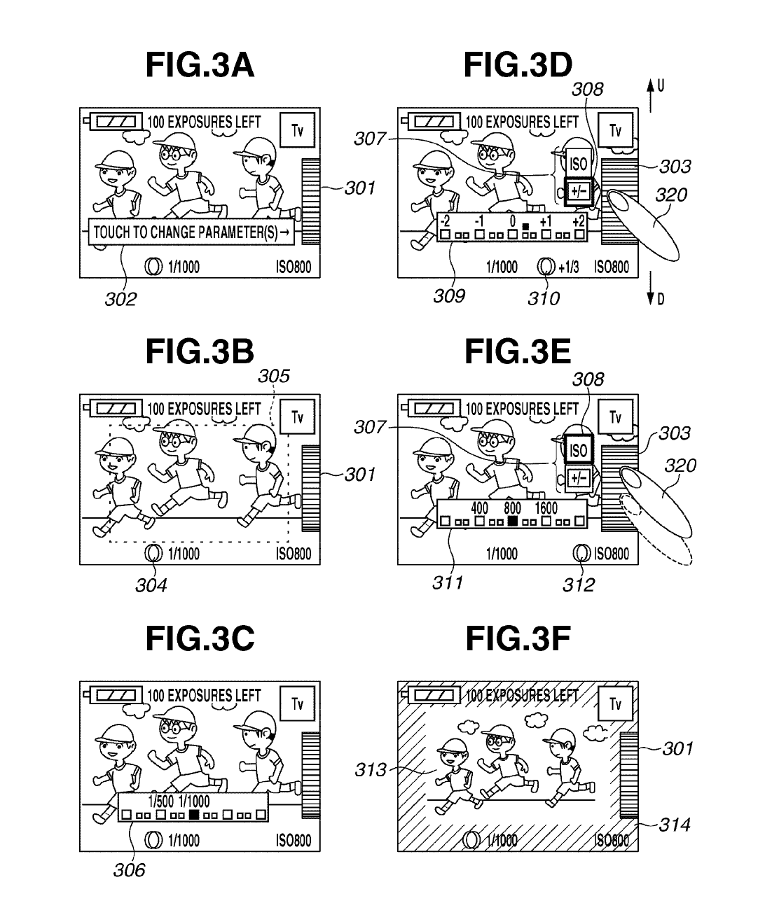

In the present exemplary embodiment, the user can operate the touch panel 108 and the controller ring 110 in combination to change three or more types of parameters by a rotating operation of the controller ling 110. Screen transitions in a touch & ring operation will be described below with reference to FIGS. 3A to 3F.

FIG. 3A illustrates a display example of the display unit 101 when a photographing mode is set to a shutter speed priority mode (hereinafter, referred to as Tv mode). FIG. 3A illustrates an initial display example when the Tv mode is activated without a touch of the touch panel 108 (touch-off). As illustrated in FIG. 3A, a pullout 301 and a guide message 302 are displayed as superimposed on a through image. The pullout 301 is a display item indicating that the user can touch this area or its vicinity to pull out and display a touch ring 303. The touch ring 303 is a display item resembling a rotatable operation member. In other words, the pullout 301 is a handle of closed drawer to open the drawer, and the touch ring 303 is opened drawer. The pullout 301 according to the present exemplary embodiment is a reduced display of the touch ring 303. The guide message 302 indicates that the display area of the pullout 301 can be touched to set various types of parameters from the controller ring 110. The guide message 302 hides automatically if a predetermined time (several seconds or so) has lapsed after the Tv mode is started, so that the visual recognition of the through image will not be hindered.

FIG. 3B illustrates a display example when a predetermined time has elapsed without a touch after the activation of the Tv mode. In FIG. 3B, the guide message 302 has disappeared. An operation guide 304 is displayed next to a numerical value of 1/1000 which is the currently-set Tv value (shutter speed). The operation guide 304 indicates that the controller ring 110 can be rotated in this state (without a touch) to change the Tv value. In such a state, the user can makes a touch-down inside a frame representing a touch AF capable area 305 to perform photographing with an object in the touch-down position designated as a main object. The touch AF capable area 305 is an area where AF can be performed on a touched-down object. For example, if there is a person's face in the touch-down position, the digital camera 100 performs face AF or tracking AF treating the face as a main object. If there is no person's face in the touch-down position, the digital camera 100 sets the position as a focus adjustment position or tracks an object lying in the touch-down position by using a contrast or color of the object in that position. Note that the frame of the touch AF capable area 305 is illustrated for the sake of convenience. The frame need not be displayed.

FIG. 3C illustrates a display example when the user has rotated the controller ring 110 without touching the touch panel 108 in the Tv mode. The digital camera 100 can change the setting of the Tv value according to the rotation direction and the amount of rotation of the controller ring 110. In response to the rotation of the controller ring 110, a Tv value setting dialog 306 is displayed. The Tv value setting dialog 306 includes a scale that indicates possible settings of the Tv value. The Tv value setting dialog 306 is cleared (hidden) when another operation (a touch-down on the touch panel 108 or an operation on a different operation member included in the operation units 107) is made or when a predetermined time (several seconds or so) has elapsed after the end of the operation on the controller ring 110.

FIG. 3D illustrates a display example when the user has touched the display area of the pullout 301 or its vicinity in the Tv mode. If the user touches the pullout 301 in the state of FIGS. 3A to 3C, the display area of the pullout 301 is expanded to display the touch ring 303 as illustrated in FIG. 3D. The touch ring 303 is displayed as long as the touch ring 303 continues to be touched with a finger 320 in the touch-on state. If the user rotates the controller ring 110 with the touch ring 303 displayed in the touch-on state, the user can change a sub function 1 and a sub function 2, which are two types of parameters different from the Tv value (main function) at the time of the touch-off. The main function corresponds to a first type. The sub functions 1 and 2 correspond to second and third types, respectively.

The user can switch the sub functions 1 and 2 by making a move while the touch ring 303 is displayed. Specifically, if the user makes the move in a downward direction D (first direction) with the touch ring 303 displayed, the settable parameter is switched to the sub function 1. If the user makes a move in an upward direction U (second direction) with the touch ring 303 displayed, the settable parameter is switched to the sub function 2. At the time when display of the touch ring 303 starts (when no move has been made after a touch-down on the pullout 301), the sub function which was settable last time is settable. If there is no record of the last sub function, the parameter of the sub function 1 is made settable as a default sub function.

FIG. 3D illustrates a state where the parameter of an exposure correction (sub function 1) can be changed. A sub function list 307 indicating which sub function is currently settable as a parameter is displayed. Here, the sub function 1 is exposure correction. The sub function 2 is the International Organization for Standardization (ISO) sensitivity. A selection cursor 308 is displayed on the exposure correction which is currently settable as a parameter. An exposure correction value setting dialog 309 is also displayed. The exposure correction value setting dialog 309 includes a scale indicating what exposure correction value can be set by rotating the controller ring 110 in either direction. The exposure correction value setting dialog 309 displays a cursor related to the exposure correction value. An operation guide 301 is further displayed next to a numerical value of +⅓ which is the currently-set exposure correction value. The operation guide 310 indicates that the user can change the exposure correction value by rotating the controller ring 110 in this state (i.e., in the touch-on state). The sub function list 307 is cleared when the user starts to rotate the controller ring 110. The sub function list 307 is displayed again when the user continues touching or makes a move operation after the rotating operation of the controller ring 110 is performed.

FIG. 3E illustrates a display example when the function of a currently settable parameter is switched from the sub function 1 of FIG. 3D to the sub function 2. Suppose that the touch ring 303 is displayed as illustrated in FIG. 3D, and the sub function 1 (exposure correction) is selected as the settable parameter. If the user makes an upward move with the finger 320, the settable parameter is changed to the sub function 2 (ISO sensitivity). When the settable parameter is changed to the sub function 2 (ISO sensitivity), the sub function list 307 displays the selection cursor 308 on the sub function 2 (ISO sensitivity) which is currently settable as a parameter. An ISO sensitivity setting dialog 311 is also displayed. The ISO sensitivity setting dialog 311 includes a scale indicating what ISO sensitivity can be set by rotating the controller ring 110 in either direction. The ISO sensitivity setting dialog 311 also displays a cursor related to the ISO sensitivity. An operation guide 312 is further displayed next to a numerical value of ISO 800 which is the currently-set ISO sensitivity. The operation guide 312 indicates that the user can change the ISO sensitivity by rotating the controller ring 110 in such a state (i.e., in the touch-on state). The sub function list 307 is cleared when the user starts to rotate the controller ring 110. The sub function list 307 is displayed again when the user continues touching or makes a move operation after the rotating operation of the controller ring 110 is performed.

In another exemplary embodiment, an area 313 in which a through image is displayed and an area 314 in which no through image is displayed may be provided as illustrated in FIG. 3F. The touch ring 303 is arranged in the area 314 to enable a touch & ring operation without hiding the through image.

As described above, depending on the state of a touch operation, the user can set the parameters related to the three types of functions by operating the same controller ring 110. The parameter of a function to be set can be quickly switched depending on whether the touch panel 108 is being touched or whether a move has been made after a touch operation is performed. In other words, troublesome operations of switching the functions of the controller ring 110 from a menu screen become unnecessary. The user can thus quickly adjust the three types of parameters. Such an effect is particularly required when the image capturing apparatus is in a shooting standby, where photographing settings need to be quickly changed to seize a photo opportunity.

### (Flowchart of Processing for Touch & Ring Operation)

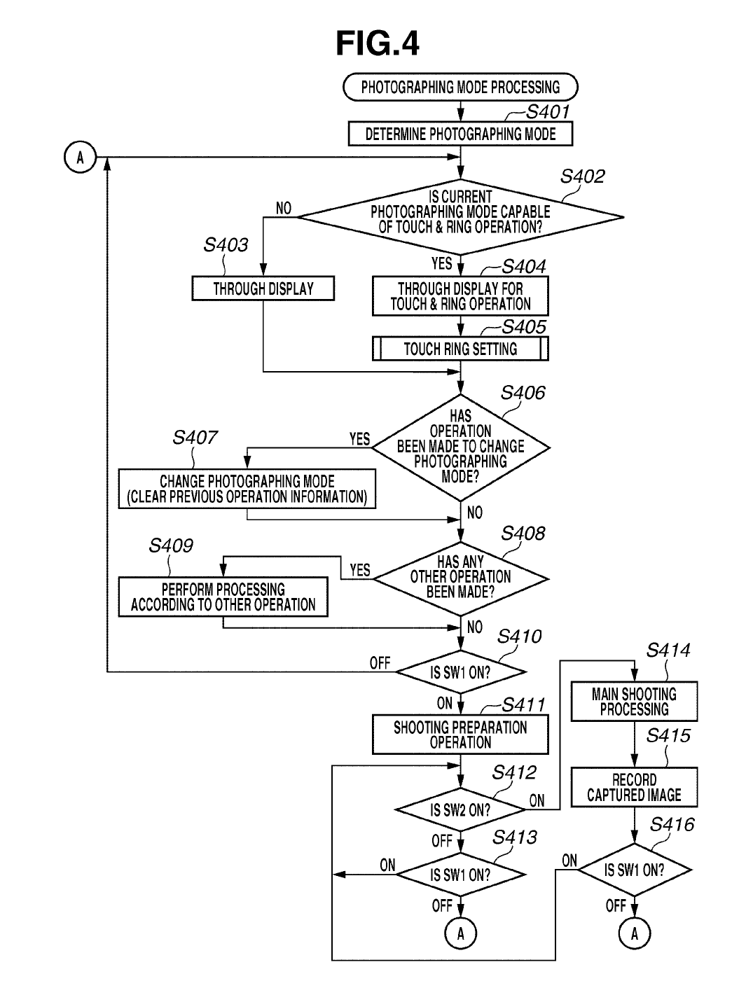

Next, processing for implementing the foregoing touch & ring operation will be described in detail. FIG. 4 is a flowchart illustrating processing in a photographing mode. Touch ring setting made by a touch & ring operation will be described below as processing during a shooting standby in the processing of the photographing mode. Each processing in the photographing mode is implemented by the system control unit 209 loading the program stored in the nonvolatile memory 216 into the system memory 217 and executing the loaded program. The processing in the photographing mode is ended by interrupt processing when the user switches from the photographing mode to another mode by using the mode changing switch 104 or when the user turns off the power switch 102.

When the user activates the digital camera 100 and switches to a photographing mode by using the mode changing switch 104, the system control unit 209 starts the processing in the photographing mode.

In step S401, the system control unit 209 determines the photographing mode. The system control unit 209 determines the photographing mode by acquiring the mode that was set the last time when a photographing mode was ended, from the nonvolatile memory 216, and storing the acquired mode into the system memory 217. The photographing mode here refers to a photographing mode for capturing a still image. For example, the digital camera 100 according to the present exemplary embodiment has the following photographing modes.

Automatic mode: a mode in which various parameters of the digital camera 100 are automatically determined by a program built in the digital camera 100 based on a measured exposure value.

Manual mode: a mode in which the user can freely change the parameters of the digital camera 100.

Av mode (aperture priority mode): a mode in which the user arbitrarily sets an aperture value (F value or Av value), and the digital camera 100 automatically sets the Tv value based on the set aperture value and a program diagram.

Tv mode (shutter speed priority mode): a mode in which the user arbitrarily sets a shutter speed (Tv value), and the digital camera 100 automatically determines the Av value based on the set shutter speed and a program diagram.

P mode (program AE mode): a mode in which the digital camera 100 automatically determines the shutter speed and the aperture value according to brightness of an object. Unlike the automatic mode, the user can freely change the combination (program) of the automatically-set shutter speed and aperture value without changing the exposure.

Scene modes: photographing modes prepared for respective photographing scenes. The digital camera 100 automatically sets an appropriate mode according to the photographing scene. The scene modes include a portrait mode, a landscape mode, a sport mode, and an underwater mode.

In step S402, the system control unit 209 determines whether the current photographing mode is capable (effective) of a touch & ring operation. In the present exemplary embodiment, the photographing modes capable of a touch & ring operation, i.e., the photographing modes where a touch & ring operation is effective among the foregoing plurality of still image photographing modes include the manual mode, the Av mode, the Tv mode, and the P mode. If the current photographing mode is one in which a touch & ring operation is effective (YES in step S402), the system control unit 209 proceeds to step S404. If not (NO in step S402), the system control unit 209 proceeds to step S403.

In step S403, the system control unit 209 provides a through display to display image data from the imaging unit 202 on the display unit 101. The through display is intended to display an image captured by the imaging unit 202 as an almost real-time moving image on the display unit 101 without recording the image on the recording medium 111. The user can view the through display to check an angle of view and shooting timing. In step S403, the system control unit 209 does not display the foregoing pullout 301 on the display unit 101 since no touch & ring operation is accepted.

In step S404, the system control unit 209 provides a through display for a touch & ring operation. The through display for a touch & ring operation displays a through image on the display unit 101 along with the pullout 301. Specifically, the system control unit 209 provides a through display which can accept a touch & ring operation illustrated in the display example of FIG. 3A. The system control unit 209 provides the through display illustrated in the display example of FIG. 3B after a lapse of a predetermined time.

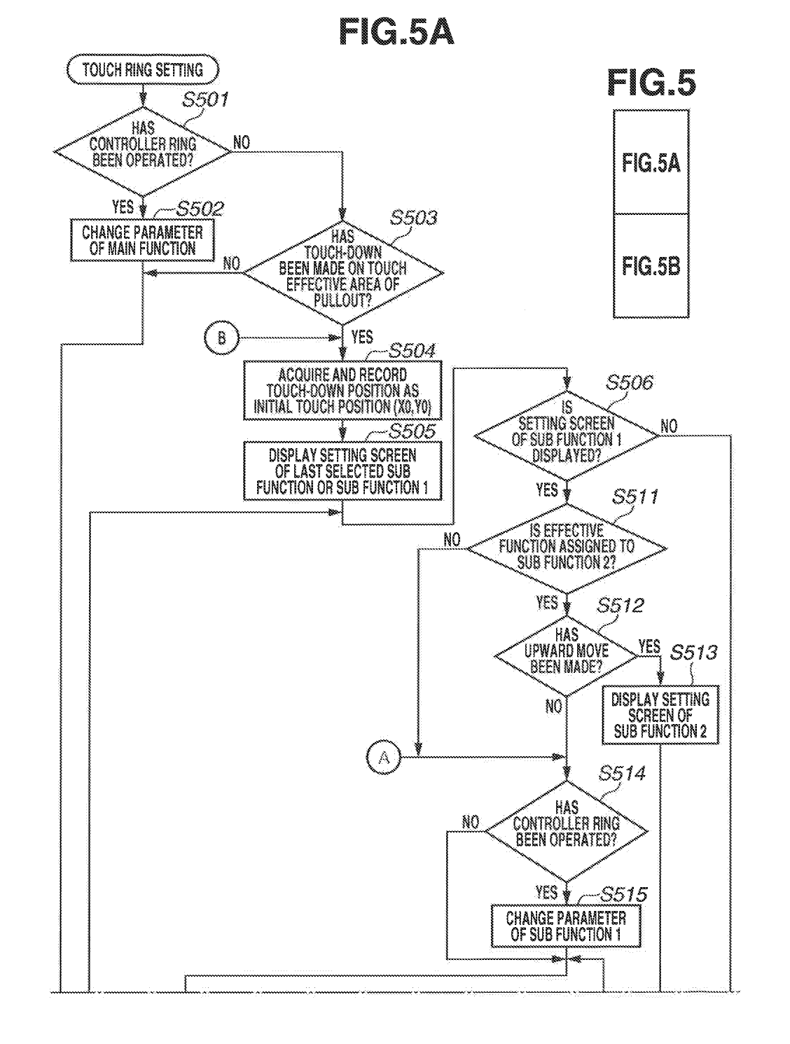

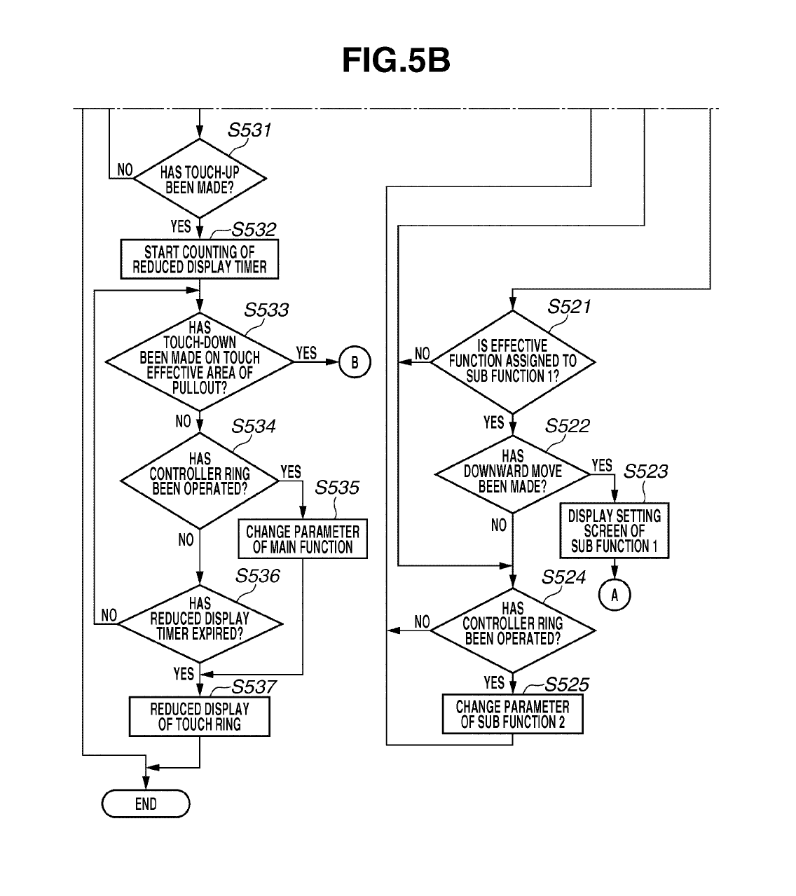

In step S405, the system control unit 209 performs touch ring setting. The touch ring setting will be described below with reference to a flowchart illustrated in FIG. 5. Touch & ring operations as described in FIGS. 3A to 3F above are accepted by the touch ring setting. In step S406, the system control unit 209 determines whether an operation has been made to change the current photographing mode to another photographing mode. If the user has made an operation to change the photographing mode by operating the mode changing switch 104 (YES in step S406), the system control unit 209 proceeds to step S407. If no operation has been made to change the photographing mode (NO in step S406), the system control unit 209 proceeds to step S408.

In step S407, the system control unit 209 changes the current photographing mode according to the operation for changing the photographing mode, and sets it to the changed photographing mode. Here, the system control unit 209 erases (clears) previous operation information that is recorded in the system memory 217 as the first sub function to be selected when a touch-down is performed on the pullout 301 (the sub function last selected in the previous touch & ring operation). Changing a photographing mode may change the functions assigned to the main function, the sub function 1, and the sub function 2, respectively. When the system control unit 209 changes the photographing mode, the system control unit 209 therefore erases the previous operation information so that a setting operation in the new photographing mode can be performed regardless of the previous operation information.

In step S408, the system control unit 209 determines whether any other operation has been made. Examples of the other operation include opening a menu screen to change various photographing settings, pressing a flash button to change a flash setting, touching the touch AF capable area 305 for touch AF, and operating the controller ring 110 to change a photographing setting. If any other operation has been made (YES in step S408), the system control unit 209 proceeds to step S409. If no other operation has been made (NO in step S408), the system control unit 209 proceeds to step S410.

In step S409, the system control unit 209 performs processing according to the other operation. In step S410, the system control unit 209 determines whether the first shutter switch signal SW1 is on (acceptance of a shooting preparation instruction). If the first shutter switch signal SW1 is off (OFF in step S410), the system control unit 209 returns to step S402. If the first shutter switch signal SW1 is on (ON in step S420), the system control unit 209 proceeds to step S411.

In step S411, the system control unit 209 performs a shooting preparation operation. Specifically, the system control unit 209 performs focusing processing to focus the shooting lens 200 on an object (AF processing) and performs light metering processing to determine an aperture value and a shutter speed (exposure determination processing). In the light metering processing, the system control unit 209 also sets the flash if needed. If a face has been detected in the through image, the system control unit 209 may perform face AF to perform focusing within the range of the detected face. At this time, the system control unit 209 also reflects various photographing parameters set by the touch & ring operation in step S405.

In step S412, the system control unit 209 determines whether the second shutter signal SW2 is on. If the second shutter switch signal SW2 is off (OFF in step S412), the system control unit 209 proceeds to step S413. If the second shutter switch signal SW2 is on (ON in step S412), the system control unit 209 proceeds to step S414.

In step S413, the system control unit 209 determines whether the first shutter switch signal SW1 is on. If the first shutter switch signal SW1 is on (ON in step S413), the system control unit 209 returns to step S412. If the first shutter switch SW1 is off (if the second shutter switch SW2 has not been turned on and the first shutter switch SW1 is released; OFF in step S413), the system control unit 209 returns to step S402.

In step S414, the system control unit 209 performs exposure and image capturing of the imaging unit 202 (main shooting processing). Here, the system control unit 209 captures an image based on the Tv value, the Av value, and the ISO sensitivity determined in the foregoing steps S405 and S409. The system control unit 209 may provide a recording review to display the captured image on the display unit 101 for several seconds so that the user can check the captured image.

In step S415, the system control unit 209 records the image captured by the main shooting processing as an image file on the recording medium 111.

In step S416, the system control unit 209 determines whether the first shutter switch signal SW1 is on. In other words, the system control unit 209 determines whether the shutter button 103 is full-pressed in the main shooting processing in step S414 and remains half-pressed without being released. If the first shutter switch signal SW1 is on (ON in step S416), the system control unit 209 returns to step S412. If the first shutter switch signal SW1 is off (OFF in step S416), the system control unit 209 returns to step S412 to repeat the processing.

### Flowchart of Touch Ring Setting

FIG. 5 is a flowchart illustrating details of the processing of the touch ring setting in step S405 of FIG. 4. The processing is implemented by the system control unit 209 loading the program recorded in the nonvolatile memory 216 into the system memory 217 and executing the loaded program.

In step S501, the system control unit 209 determines whether the controller ring 110 has been operated. If the controller ring 110 has been operated (YES in step S501), the system control unit 209 proceeds to step S502. If the controller ring 110 has not been operated (NO in step S501), the system control unit 209 proceeds to step S503. Note that in step S501, the system control unit 209 determines whether the controller ring 110 has been operated without a touch on the touch panel 108 (touch-off).

In step S502, the system control unit 209 changes the parameter of the main function according to the rotation direction and the amount of rotation of the controller ring 110 operated. If the main function is the shutter speed, the system control unit 209 provides a display including the Tv value setting dialog 306 illustrated in FIG. 3C on the display unit 101. Having changed the parameter of the main function, the system control unit 209 ends the touch ring setting and proceeds to step S406 of FIG. 4. For example, suppose that the system control unit 209 proceeds to step S406 and then detects a touch-down on the pullout 301. In such a case, the system control unit 209 proceeds from step S406 to step S408 (NO in step S406), proceeds to step S410 (NO in step S408), proceeds to step S402 (OFF in step S410), proceeds to step S404 (YES in step S402), and proceeds from step S404 to the touch ring setting of step S405 again. Then in step S503, the system control unit 209 determines that a touch-down has been made on the pullout 301 (YES in step S503).

In step S503, the system control unit 209 determines whether a touch-down has been made on a touch effective area of the pullout 301 on the touch panel 108. The touch effective area of the pullout 301 is set to be somewhat greater than the display area of the pullout 301, including the display area without overlapping with the touch AF capable area 305. The system control unit 209 therefore determines that the pullout 301 is touched even if the touched position is somewhat off the pullout 301 as long as within the touch effective area. Such processing facilitates touching the pullout 301 even when the pullout 301 is displayed in a closed form (reduced display form). If a touch-down has been made on the touch effective area of the pullout 301 (YES in step S503), the system control unit 209 proceeds to step S504. If no touch-down has been made (NO in step S503), the system control unit 209 ends the touch ring setting and proceeds to step S406.

In step S504, the system control unit 209 acquires the coordinates of the position where the touch-down has been made (touch-down position), and records the coordinates into the system memory 217 as an initial touch position (X0,Y0).

In step S505, the system control unit 209 acquires the previous operation information recorded in the system memory 217. The system control unit 209 acquires information about the sub function last selected in the previous touch & ring operation from the previous operation information, and displays a setting screen on the display unit 101 with the sub function selected by a selection cursor 308 as a parameter-changeable sub function. Such processing allows the user to quickly call a frequently-used sub function. If no previous operation information is recorded, the system control unit 209 displays a setting screen of the sub function 1 by default. As a result, the display unit 101 displays a setting screen like FIG. 3D (for the sub function 1) or a setting screen like FIG. 3E (for the sub function 2).

In step S506, the system control unit 209 determines whether the setting screen of the sub function 1 is currently displayed. If the setting screen of the sub function 1 is displayed (YES in step S506), the system control unit 209 proceeds to step S511. If the setting screen of the sub function 1 is not displayed (NO in step S506), the system control unit 209 proceeds to step S521.

In step S511, the system control unit 209 determines whether an effective function is assigned to the sub function 2 in the current photographing mode. If any effective function is assigned to the sub function 2 (YES in step S511), the system control unit 209 proceeds to step S512. If no effective function is assigned to the sub function 2 (NO in step S511), the system control unit 209 proceeds to step S514.

In step S512, the system control unit 209 determines whether an upward move has been made from the touch-down state of step S503. Specifically, the system control unit 209 compares the initial touch position (X0,Y0) recorded in the system memory 217 with the current touch position in terms of the Y coordinate. If the comparison result shows a difference is equal to a predetermined value or more and the direction of change is upward, the system control unit 209 determines that an upward move has been made. Here, the amount of change in the X component (component in the lateral direction of the display unit 101) is not taken into account. If an upward move is determined to have been made (YES in step S512), the system control unit 209 proceeds to step S513. If an upward move is determined not to have been made (NO in step S512), the system control unit 209 proceeds to step S514.

In step S513, the system control unit 209 switches the parameter-changeable function from the sub function 1 to the sub function 2, and displays the setting screen of the sub function 2 on the display unit 101. As a result, the display unit 101 changes the setting screen from FIG. 3D to FIG. 3E. Having displayed the setting screen of the sub function 2, the system control unit 209 proceeds to step S524.

In step S514, the system control unit 209 determines whether the controller ring 110 has been operated. If the controller ring 110 has been operated (YES in step S514), the system control unit 209 proceeds to step S515. If the controller ring 110 has not been operated (NO in step S514), the system control unit 209 proceeds to step S531. Note that in step S514, the system control unit 209 determines whether the controller ring 110 has been operated with the touch panel 108 touched (touch-on).

In step S515, the system control unit 209 changes the parameter of the sub function 1 according the rotation direction and the amount of rotation of the controller ring 110 operated. The system control unit 209 records the information about the sub function 1 and the information about the changed parameter into the system memory 217 as operation information.

In step S506, if the setting screen of the sub function 1 is not displayed (NO in step S506), the system control unit 219 proceeds to step S521. In step S521, the system control unit 209 determines whether an effective function is assigned to the sub function 1 in the current photographing mode. If any effective function is assigned to the sub function (YES in step S521), the system control unit 209 proceeds to step S522. If no effective function is assigned to the sub function (NO in step S521), the system control unit 209 proceeds to step S524.

In step S522, the system control unit 209 determines whether a downward move has been made from the touch-down state of FIG. 503. Specifically, the system control unit 209 compares the initial touch position (X0,Y0) recorded in the system memory 217 with the current touch position in terms of the Y coordinate. If the comparison result shows a difference is equal to a predetermined value or more and the direction of change is downward, the system control unit 209 determines that a downward move has been made. Here, the amount of change in the X component (component in the lateral direction of the display unit 101) is not taken into account. If a downward move is determined to have been made (YES in step S522), the system control unit 209 proceeds to step S523. If a downward move is determined not to have been made (NO in step S522), the system control unit 209 proceeds to step S524.

In step S523, the system control unit 209 switches the parameter-changeable function from the sub function 2 to the sub function 1, and displays the setting screen of the sub function 1 on the display unit 101. As a result, the display unit 101 changes the setting screen from FIG. 3E to FIG. 3D. Having displayed the setting screen of the sub function 1, the system control unit 209 proceeds to step S514.

In step S524, the system control unit 209 determines whether the controller ring 110 has been operated. If the controller ring 110 has been operated (YES in step S524), the system control unit 209 proceeds to step S525. If the controller ring 110 has not been operated (NO in step S524), the system control unit 209 proceeds to step S531. Note that in step S524, the system control unit 209 determines whether the controller ring 110 has been operated with the touch panel 108 touched (touch-on).

In step S525, the system control unit 209 changes the parameter of the sub function 2 according to the rotation direction and the amount of rotation of the controller ring 110 operated. The system control unit 209 records the information about the sub function 2 and the information about the changed parameter into the system memory 217 as operation information.

In step S531, the system control unit 209 determines whether a touch-up has been made. If a touch-up is determined not to have been made (NO in step S531), i.e., if the touch-on has been continued since step S503, the system control unit 209 returns to step S506. If a touch-up is determined to have been made (YES in step S531), the system control unit 209 proceeds to step S532. As can be seen from the processing so far, while in the touch-on state started by the touch-down on the pullout 301, the system control unit 209 performs no control according to the touch position except using a move in the Y direction to switch between the sub functions 1 and 2. More specifically, the system control unit 209 maintains the state which enables parameter change of a sub function even if the touch position deviates from the display area of the touch ring 303. The system control unit 209 performs no touch AF, even if a move to the touch AF capable area 305 is made. Such processing prevents an unintended operation if the user touches the pullout 301 with a finger of the hand gripping the digital camera 100 and then the touching finger accidentally deviates while the user operates the controller ring 110 to rotate with the other hand. Specifically, when the user is rotating the controller ring 110, the holding force of the hand gripping the digital camera 100 also increases and the touching finger tends to deviate unintentionally. Even in such a case, the foregoing processing can effectively avoid the occurrence of an operation error.

In step S532, the system control unit 209 starts counting of a reduced display timer (about one to two seconds).

In step S533, the system control unit 209 determines whether a touch-down has been made on the touch effective area of the pullout 301 on the touch panel 108. If a touch-down has been made on the touch effective area of the pullout 301 (YES in step S533), the system control unit 209 proceeds to step S504. If no touch-down has been made (NO in step S533), the system control unit 209 proceeds to step S534.

In step S534, the system control unit 209 determines whether the controller ring 110 has been operated. If the controller ring 110 has been operated (YES in step S534), the system control unit 209 proceeds to step S535. If the controller ring 110 has not been operated (NO in step S534), the system control unit 209 proceeds to step S536.

In step S535, the system control unit 209 changes the parameter of the main function according to the rotation direction and the amount of rotation of the controller ring 110 operated.

In step S536, the system control unit 209 determines whether the reduced display timer started in step S532 has expired. In other words, this processing determines whether a predetermined time has elapsed since the touch-up. If the timer has expired (YES in step S536), the system control unit 209 proceeds to step S537. If the timer has not expired (NO in step S536), the system control unit 209 returns to step S533.

In step S537, the system control unit 209 provides the reduced display of the touch ring 303 to enter the untouched display state like FIG. 3B. The system control unit 209 ends the touch ring setting and proceeds to step S406 of FIG. 4.

The processing of the foregoing steps S532 to S537 prevents the system control unit 209 from immediately providing the reduced display of the touch ring 303 intended for the sub functions even if a touch-up is made in a state where the touch ring 303 has been displayed during a touch-on. Such processing allows the user to fully examine the parameter that has been under operation during the touch-on and the result of the operation.

On the other hand, if the controller ring 110 is operated soon after a touch-up, the system control unit 209 changes the parameter of the main function and immediately ends displaying of the touch ring 303. Such processing can instantly switch the change target parameters in response to a touch-up, whereby the parameters of a plurality of functions can be quickly changed.

If the controller ring 110 is rotated before the expiration of the reduced display timer after a touch-up, the system control unit 209 may change the parameter of the last-selected sub function instead of the main function. Such processing may slightly hinder a quick change from the sub function to the main function, but can prevent an operation error of unintentionally changing the parameter of the main function when the user accidentally makes a touch-up during the rotation of the controller ring 110.

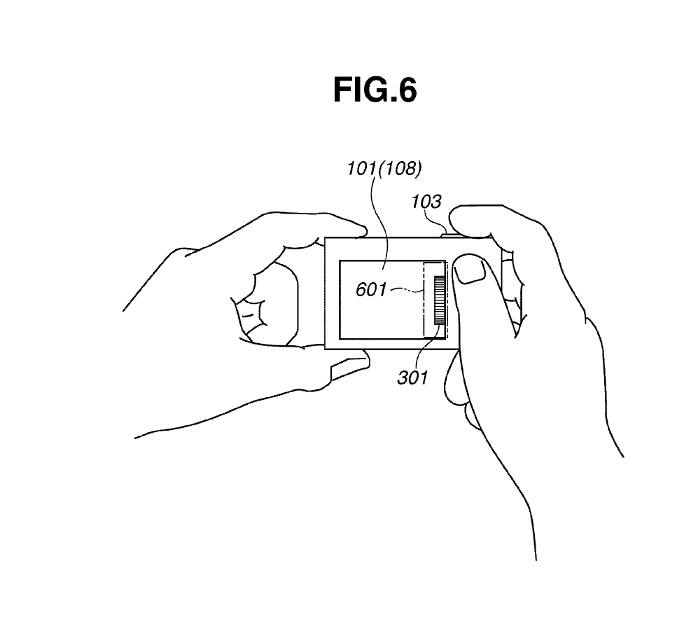

In the present exemplary embodiment, as illustrated in FIG. 6, the display area of the pullout 301 is arranged in a peripheral area 601 of a grip side among four sides of the touch panel 108, (the side where the shutter button 103 is arranged). When the display area of the pullout 301 is arranged in such a position, the user can touch the pullout 301 with the thumb of the right hand gripping the digital camera 100. The user can thus make the operation of switching the sub functions with the right thumb while operating the controller ring 110 to change the parameter with the opposite left hand. Such a configuration enables quick change of the parameters of a plurality of functions by effectively using both left and right hands.

Respective different functions can be assigned to the main function and the sub functions according to the photographing mode. Examples of effective assignment patterns will be described.

TABLE 1

| | Manual mode | Av mode | Tv mode | P mode |
|---|---|---|---|---|
| Main | Aperture | Aperture | Shutter | ISO |
| function | | | speed | sensitivity |
| Sub | Shutter | Exposure | Exposure | Exposure |
| function 1 | speed | correction | correction | correction |
| Sub | ISO | ISO | ISO | None |
| function 2 | sensitivity | sensitivity | sensitivity | |

Table 1 illustrates an example of the function assignment according to the photographing mode. Photographing setting items include four types of exposure-related photographing settings including an aperture value, a shutter speed, an ISO sensitivity, and exposure correction. Of these, photographing setting items that seem to have the highest use frequency in the respective photographing modes are assigned to the main function. The other photographing setting items are assigned to the sub functions 1 and 2.

Such assignment allows the user to change the most commonly used parameter in the current photographing mode by operating only the controller ring 110 without performing a touch. This improves the operability. In addition, the user can easily and quickly change the other exposure-related parameters according to a touch operation. In other words, the user can quickly adjust the four types of parameters needed for exposure determination by using only the two types of operation members, namely, the controller ring 110 and the touch panel 108. This enables image capturing with desired exposure settings without losing photo-opportunities.

TABLE 2

| | Manual mode | Av mode | Tv mode | P mode |
|---|---|---|---|---|
| Main | Zoom | Zoom | Zoom | Zoom |
| function | operation | operation | operation | operation |
| Sub | Aperture | Aperture | Shutter | ISO |
| function 1 | | | speed | sensitivity |
| Sub | Shutter | Exposure | Exposure | Exposure |
| function 2 | speed | correction | correction | correction |
| Sub | ISO | ISO | ISO | None |
| function 3 | sensitivity | sensitivity | sensitivity | |

Table 2 illustrates another example of the function assignment that seems to be effective. In this example, a zoom operation is assigned to the main function.

Such assignment allows the user to make a zoom operation (optical zooming to drive the zoom lens, or electronic zooming) by operating only the controller ring 110 in all the photographing modes. The user can change the exposure-related parameters by operating the controller ring 110 while touching. Since the exposure-related functions are assigned to the sub functions and the other commonly-used function to the main function, the user can adjust exposure by rotating the controller ring 110 with a touch operation. This can provide an intuitive, easy-to-understand operation feeling to the user. Photographing settings other than the zoom operation may be assigned to the main function. For example, manual focusing, dynamic range correction, dark portion correction, white balance (WB) correction, contrast correction, aspect switching, and a focus operation may be assigned to the main function.

In Table 2, the assigned sub functions include the sub function 3 aside from the sub functions 1 and 2. In other words, the sub functions are not limited to two types and may include three or more types. The three or more types of sub functions may be switched according to a degree of a move of the touching finger in the Y direction. For example, if the user makes a downward move beyond a threshold 1 in the Y direction with the sub function 1 selected, the system control unit 209 may switch to the sub function 2. If the user makes a downward move beyond a threshold 2 that is greater than the threshold 1, the system control unit 209 may switch to the sub function 3. By such processing, three or more sub functions can be switched.

TABLE 3

| | First | Second | Third | Fourth |
|---|---|---|---|---|
| | filter | filter | filter | filter |
| Main | Fine | Soft | Fish- | Monochromatic |
| function | skin | focusing | eyed | |
| Sub | Fine | Effect | Effect | Tone |
| function 1 | skin | (high/ | high/ | (black and |
| | effect | medium/ | medium/ | white/sepia/ |
| | | low) | low) | blue and white) |
| Sub | Skin color | None | None | Color effect |
| function 2 | effect | | | (red/green/ |
| | | | | blue) |

Table 3 illustrates an example of assignment when creative filters are selected. The main function is used to set a filter type such as fine skin and soft focusing. The sub functions 1 and 2 are used to select the effects of the filters. The user can thus easily switch the filters and their effects.

As has been described above, according to the present exemplary embodiment, the controller ring (physical rotatable operation member) 110 and the touch panel 108 can be combined to quickly and easily select three or more types of functions the user frequently uses. The user can also use the controller ring 110 to change the setting value of a selected function with high operability.

The present exemplary embodiment has dealt with the case where the controller ring 110 is combined with the touch panel 108. However, an exemplary embodiment of the present invention may be realized by combining the controller ring 110 with an operation member that is capable of two or more types of operations. For example, an exemplary embodiment of the present invention can be realized by combining the controller ring 110 with an operation member that can be vertically tilted, such as a joy stick and arrow keys. If a joy stick is used as the operation member, the foregoing touch ring setting can be implemented when an operation of tilting the joy stick upward corresponds to an upward move and an operation of tilting the joy stick downward corresponds to a downward move.

The control of the system control unit 209 may be performed by a single piece of hardware. Alternatively, the entire electronic apparatus may be controlled by a plurality of pieces of hardware sharing the processing.

While the present invention has been described in detail based on the preferred exemplary embodiment thereof, the present invention is not limited to the foregoing specific exemplary embodiment. Various forms falling within a range not departing from the gist of the present invention are also included in the present invention.

The foregoing exemplary embodiment has been described by applying the present invention to the digital camera 100 as an example. However, an exemplary embodiment of the present invention is not limited to such a case, and may be applied to any electronic apparatus that switches a plurality of types of parameters. Specifically, an exemplary embodiment of the present invention may be applied to a personal computer, a personal digital assistant (PDA), a mobile phone, a portable image viewer, a printer apparatus including a display, a digital photo frame, a music player, a game machine, and an electronic book reader.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-183526 filed Aug. 22, 2012, which is hereby incorporated by reference herein in its entirety.

1. An electronic apparatus comprising:
a first operation unit;
a second operation unit capable of accepting a touch operation; and
a control unit configured to perform control to change a parameter of a first type if the first operation unit is operated without the touch operation performed on the second operation unit, and to change a parameter of a plurality of types including at least a second type and a third type if the first operation unit is operated while the touch operation is performed on the second operation unit.

2. The electronic apparatus according to claim 1, wherein the control unit is configured to perform control to, change a parameter of one of the plurality of types according to the touch operation if the touch operation is performed on a specific area of the second operation unit.

3. The electronic apparatus according to claim 2, wherein the specific area is an area adjoining a side of the second operation unit closest to a grip side of the electronic apparatus.

4. The electronic apparatus according to claim 2, wherein the control unit is configured to change the parameter of the type according to the touch operation even if a touch position of the touch operation moves out of the specific area while the touch operation started on the specific area is continued.

5. The electronic apparatus according to claim 1, further comprising a recording unit configured to record operation information about one of the plurality of types that has been changed last time,
wherein the control unit is configured to change the parameter of the one of the plurality of types based on the operation information recorded in the recording unit if the first operation unit is operated before a touch position is moved while the touch operation started on the second operation unit is continued.

6. The electronic apparatus according to claim 1, wherein the control unit is configured to change a parameter of one of the plurality types according to a movement of a touch position while the touch started by the touch-down on the second operation unit is continued.

7. The electronic apparatus according to claim 6, wherein the control unit is configured to switch the parameter to the third type if the touch operation includes a movement in a first direction, and to switch the parameter to the second type if the touch operation includes a move in a second direction opposite from the first direction.

8. The electronic apparatus according to claim 7, wherein the first and second directions are vertical directions.

9. The electronic apparatus according to claim 1, further comprising a display control unit configured to control display of a display unit arranged to overlap the second operation unit,
wherein the display control unit is configured to, if no touch operation is performed on the second operation unit, display a pullout for displaying a display item for guiding the touching operation in a pulled-out manner, and if a predetermined area including an area where the pullout is displayed is touched, display the display item, and
wherein the control unit is configured to, if the first operation unit is operated while a touch operation is continuing since a touch on the display item, change a parameter of a type according to the touch operation, among the plurality of types.

10. The electronic apparatus according to claim 9, wherein the electronic apparatus is an image capturing apparatus, and
wherein the predetermined area is an area not overlapping a touch AF capable area where AF can be performed on a touched object.

11. The electronic apparatus according to claim 9, wherein the display control unit is configured to display the display item until a predetermined time elapses after the touch operation continuing since the touch on the display item is released, and delete the display item and display the pullout after the predetermined time has elapsed, and
wherein the control unit is configured to, if the first operation unit is operated before the predetermined time elapses after the touch operation continuing since the touch on the display item is released, change the parameter of the first type.

12. The electronic apparatus according to claim 9, wherein the electronic apparatus is an image capturing apparatus including an imaging unit, and
the predetermined area is an area not overlapping an area where an image captured by the imaging unit is displayed on the display unit.

13. The electronic apparatus according to claim 1, wherein the first operation unit is an operation member operable in a first direction and a second direction different from the first direction.

14. The electronic apparatus according to claim 13, wherein the operation member includes a rotatable operation member.

15. The electronic apparatus according to claim 14, wherein the electronic apparatus is an image capturing apparatus including a lens barrel, and
wherein the rotatable operation member is an operation member configured to rotate around the lens barrel.

16. The electronic apparatus according to claim 1, wherein the parameters of the first, second, and third types include any of exposure correction, an ISO sensitivity, an aperture value, and a shutter speed related to image capturing by an imaging unit.

17. The electronic apparatus according to claim 1, wherein the parameter of the first type includes any of a zoom operation, WB correction, contrast correction, aspect switching, and a focus operation related to image capturing by an imaging unit, and
the parameters of the second and third types include any of exposure correction, an ISO sensitivity, an aperture value, and a shutter speed related to the image capturing by the imaging unit.

18. The electronic apparatus according to claim 1, wherein the first type is a type of a filter which is a parameter related to image capturing by an imaging unit, and
wherein the second and third types are an effect of the filter.

19. A method for controlling an electronic apparatus including a first operation unit and a second operation unit capable of accepting a touch operation, the method comprising performing control to change a parameter of a first type if the first operation unit is operated without a touch operation performed on the second operation unit and change a parameter of one of a plurality of types if the first operation unit is operated while performing a touch operation on the second operation unit, the plurality of types including at least a second type and a third type.

20. An electronic apparatus comprising:
a first operation unit;
a second operation unit capable of accepting a touch operation; and
a control unit configured to perform control to change a parameter of a first type if the first operation unit is operated without a touch operation performed on the second operation unit and change a parameter of a type different from the first type if the first operation unit is operated while performing a touch operation on a specific area adjoining a side of the second operation unit closest to a grip side.

21. The electronic apparatus according to claim 20, wherein the control unit is configured to change the parameter of the different type even if a touch position of the touch operation on the second operation unit moves out of the specific area while a touch started on the specific area is continuing.

22. The electronic apparatus according to claim 20, further comprising a display control unit configured to control display of a display unit arranged to overlap the second operation unit,
wherein the display control unit is configured to, if no touch operation is performed on the second operation unit, display a pullout for displaying a display item for guiding the touching operation in a pulled-out manner, and if a predetermined area including an area where the pullout is displayed is touched, display the display item, and
wherein the control unit is configured to, if the first operation unit is operated while a touch operation is continuing since a touch on the display item, change the parameter of the different type.

23. The electronic apparatus according to claim 22, wherein the electronic apparatus is an image capturing apparatus, and
wherein the predetermined area is an area not overlapping a touch AF capable area where AF can be performed on a touched object.

24. The electronic apparatus according to claim 22, wherein the display control unit is configured to display the display item until a predetermined time elapses after a touch operation continuing since a touch on the display item is released, and delete the display item and display the pullout after the predetermined time has elapsed, and
wherein the control unit is configured to, if the first operation unit is operated before the predetermined time elapses after the touch operation continuing since the touch on the display item is released, change the parameter of the first type.

25. The electronic apparatus according to claim 22, wherein the electronic apparatus is an image capturing apparatus including an imaging unit, and
wherein the predetermined area is an area not overlapping an area where an image captured by the imaging unit is displayed on the display unit.

26. The electronic apparatus according to claim 20, wherein the first detection unit is an operation member operable in a first direction and a second direction different from the first operation.

27. The electronic apparatus according to claim 26, wherein the operation member is a rotatable operation member.

28. The electronic apparatus according to claim 27, wherein the electronic apparatus is an image capturing apparatus including a lens barrel, and
wherein the rotatable operation member is an operation member configured to rotate around the lens barrel.

29. The electronic apparatus according to claim 20, wherein the first, second, and third types are any one of exposure correction, an ISO sensitivity, an aperture value, and a shutter speed which are parameters related to image capturing by an imaging unit.

30. The electronic apparatus according to claim 20, wherein the first type is any one of a zoom operation, WB correction, contrast correction, aspect switching, and a focus operation which are parameters related to image capturing by an imaging unit, and
wherein the second and third types each are any one of exposure correction, an ISO sensitivity, an aperture value, and a shutter speed which are parameters related to the image capturing by the imaging unit.

31. The electronic apparatus according to claim 20, wherein the first type is a type of a filter which is a parameter related to image capturing by an imaging unit, and
wherein the second and third types are an effect of the filter.

32. A method for controlling an electronic apparatus including a first operation unit and a second operation unit capable of accepting a touch operation, the method comprising performing control to, if the first operation unit is operated without a touch operation on the second operation unit, change a parameter of a first type, and if the first operation unit is operated with a touch operation performed on a specific area adjoining a side of the second operation unit which is the closest to a grip side, change a parameter of a type different from the first type.

33. An image capturing apparatus comprising:
a shutter operation member configured to accept a shooting instruction;
a first operation unit;
a second operation unit capable of accepting a touch operation; and
a control unit configured to perform control to, if the first operation unit is operated without a touch operation on the second operation unit, change a parameter of a first type, and if the first operation unit is operated with a touch operation performed on a specific area adjoining a vertical side of the second operation unit which is close to the shutter operation member, change a parameter of a type different from the first type.

34. A method for controlling an image capturing apparatus including a shutter operation member configured to accept a shooting instruction, a first operation unit, and a second operation unit capable of accepting a touch operation, the method comprising performing control to, if the first operation unit is operated without a touch operation on the second operation unit, change a parameter of a first type, and if the first operation unit is operated with a touch operation performed on a specific area adjoining a vertical side of the second operation unit which is close to the shutter operation member, change a parameter of a type different from the first type.

35. A non-transitory computer-readable storage medium storing a program for causing a computer including a first operation unit and a second operation unit capable of accepting a touch operation to perform control to, if the first operation unit is operated without a touch operation on the second operation unit, change a parameter of a first type, and if the first operation unit is operated with a touch operation on the second operation unit, change a parameter of a type according to the touch operation, among a plurality of types including at least a second type and a third type.

36. A non-transitory computer-readable storage medium storing a program for causing a computer including a first operation unit and a second operation unit capable of accepting a touch operation to perform control to, if the first operation unit is operated without a touch operation on the second operation unit, change a parameter of a first type, and if the first operation unit is operated with a touch operation performed on a specific area adjoining a side of the second operation unit which is the closest to a grip side, change a parameter of a type different from the first type.

37. A non-transitory computer-readable storage medium storing a program for causing an image capturing apparatus including a shutter operation member configured to accept a shooting instruction, a first operation unit, and a second operation unit capable of accepting a touch operation to perform control to, if the first operation unit is operated without a touch operation on the second operation unit, change a parameter of a first type, and if the first operation unit is operated with a touch operation performed on a specific area adjoining a vertical side of the second operation unit which is close to the shutter operation member, change a parameter of a type different from the first type.
